(19) United States
(12) Patent Application Publication
(10) Pub. No.: US 2015/0042554 A1
(43) Pub. Date: Feb. 12, 2015

(54) METHOD FOR ADJUSTING SCREEN DISPLAYING MODE AND ELECTRONIC DEVICE

(71) Applicant: Wistron Corporation, New Taipei City (TW)

(72) Inventors: Tsung-Yuan Chen, New Taipei City (TW); Yung-Yen Chang, New Taipei City (TW); Yen-Yu Lee, New Taipei City (TW)

(73) Assignee: Wistron Corporation, New Taipei City (TW)

(21) Appl. No.: 14/072,796

(22) Filed: Nov. 6, 2013

(30) Foreign Application Priority Data
Aug. 6, 2013 (TW) 102128108

(51) Int. Cl. G09G 5/32; G06F 3/01

(52) U.S. Cl. CPC G09G 5/32; G06F 3/011
USPC 345/156

(57) ABSTRACT

A method for adjusting screen displaying mode and an electronic device suitable for the method are provided; the electronic device has a body sensor. The method includes: determining whether the body sensor has detected a body contact; when the body contact is detected by the body sensor, not adjusting a screen displaying mode of the electronic device; when the body contact is not detected by the body sensor, determining whether to adjust the screen displaying mode of the electronic device according to a tilt status of the electronic device.

### CROSS-REFERENCE TO RELATED APPLICATION

This application claims the priority benefit of Taiwan application serial no. 102128108, filed on Aug. 6, 2013. The entirety of the above-mentioned patent application is hereby incorporated by reference herein and made a part of this specification.

### BACKGROUND

1. Field of the Invention

The invention relates to an electronic device, and more particularly, to a method for adjusting a screen displaying mode and an electronic device.

2. Description of Related Art

Currently, most smartphones support an automatic rotating display function. For example, a smartphone determines whether or not to rotate the display of a screen through a sensing result of a G-sensor disposed in the smartphone. For example, when the smartphone is at a horizontal status, according to a sensing result of the G-sensor, the display of the smartphone would correspondingly to adjust to a horizontal display. On the contrary, when the smartphone is at a vertical status, the display of the smartphone would maintain a vertical display.

However, the automatic rotating display function sometimes causes the user inconvenience. For example, when the user is lying on a bed and using the smartphone, the smartphone would be in a horizontal status. However, if the user does not want to adjust the display to be horizontal corresponding to a horizontal status of the smartphone, then the user would need to perform an additional operation, such as turning off the automatic rotating display function, in order to maintain a vertical display.

Thus, how to effectively comply with both an automatic rotating display as well as user experience is an issue those in this field are dedicated to researching.

### SUMMARY

Accordingly, the invention provides a method for adjusting a screen displaying mode and an electronic device, adapted to effectively improve the problem of having to comply with both an automatic rotating display as well as user experience.

The invention provides a method for adjusting a screen displaying mode, adapted for an electronic device having a body sensor. The method includes: determining whether the body sensor detects a body contact; when the body sensor detects a body contact, not adjusting the screen displaying mode of the electronic device; when the body sensor does not detect a body contact, determining whether to adjust the screen displaying mode of the electronic device according to a tilt status of the electronic device.

In an embodiment of the invention, the step of determining whether to adjust the screen displaying mode of the electronic device according to a tilt status of the electronic device comprises: determining a target screen displaying mode corresponding to a tilt angle of the electronic device; determining whether a current screen displaying mode and the target screen displaying mode are the same; when the current screen displaying mode and the target screen displaying mode are different, adjusting the screen displaying mode of the electronic device from the current screen displaying mode to the target screen displaying mode.

In an embodiment of the invention, the step of determining whether the body sensor has detected the body contact includes: determining if a tilt angle of the electronic device has changed from a first preset tilt angle range to a second preset tilt angle range; when the tilt status of the electronic device has changed from a first preset tilt angle range to a second preset tilt angle range, then determining whether the body sensor detects a body contact.

In an embodiment of the invention, the step of determining whether a body sensor detects a body contact includes: sending a query signal to a basic input output system (BIOS) of the electronic device; the BIOS searching for a sensing parameter in a record table in response to the query signal, and generating a response signal according to the sensing parameter; determining whether the at least one body sensor has detected the body contact according to the response signal.

In an embodiment of the invention, the record table is stored in an embedded controller of the electronic device, and the method includes: when the body sensor detects a body contact, the embedded controller sets a sensing parameter of the of the record table as a first value; when the body sensor does not detect a body contact, the embedded controller sets a sensing parameter of the of the record table as a second value.

In an embodiment of the invention, the step of determining whether to adjust the screen displaying mode of the electronic device according to a tilt status of the electronic device includes: the embedded controller of the electronic device changing the first value from the sensing parameter of the record table to a second value, and sending an interruption signal to the BIOS of the electronic device; the BIOS and searching for the sensing parameters from the records of the record table in response to the interruption signal, and generating a notification signal according to the sensing parameter; obtaining a tilt status of the electronic device through a G-sensor of the electronic device in response to the notification signal, and determining whether to adjust the screen displaying mode of the electronic device according to the tilt status of the electronic device.

In an embodiment of the invention, the body sensor includes a first body sensor and a second body sensor. The first body sensor is disposed on a first side of the body of the electronic device, and the second body sensor is disposed on a second side of the body of the electronic device opposite to the first side.

In an embodiment of the invention, a midpoint line of the first side and the second side is substantially parallel to a reference line. The reference line is a connection line of the two eyes of a user viewing the electronic device when the electronic device is in a screen displaying mode.

The invention further provides an electronic device. The electronic device includes a body sensor, a G-sensor, and a screen adjusting module. The body sensor is respectively configured to sense a body contact. The G-sensor is configured to detect a tilt status of the electronic device. The screen adjusting module is coupled to the body sensor and the G-sensor, and is configured to determine whether the body sensor has detected a body contact. When the body sensor detects a body contact, the screen adjusting module does not adjust a screen displaying mode of the electronic device. When the body sensor does not detect a body contact, the screen adjusting module determines whether to adjust a screen displaying mode of the electronic device according to the tilt status of the electronic device.

In an embodiment of the invention, the screen adjusting module is further configured to determine the target screen displaying mode corresponding to a tilt angle of the electronic device. The screen adjusting module is further configured to determine if a current screen displaying mode of the electronic device is the same as the target screen displaying mode. When the current screen displaying mode of the electronic device is different from the target screen displaying mode, the screen adjusting module is further configured to adjust the screen displaying mode of the electronic device from the current screen displaying mode to the target screen displaying mode.

In an embodiment of the invention, the screen adjusting module is further configured to determine if a tilt angle of the electronic device has changed from a first preset tilt angle range to a second preset tilt angle range. When the tilt angle of the electronic device has changed from the first preset tilt angle range to the second preset tilt angle range, the screen adjusting module then determines if the body sensor has detected a body contact.

In an embodiment of the invention, the screen adjusting module includes a processor and a BIOS. The processor is coupled to the G-sensor, and the BIOS is coupled to the processor. The processor is configured to send a query signal to the BIOS. The BIOS is configured to search for a sensing parameter recorded in a record table in response to the query signal, and generate a response signal according to the sensing parameter. The processor is further configured to determine if the body sensor has detected a body contact according to the response signal.

In an embodiment of the invention, the screen adjusting module further includes an embedded controller. The embedded controller is coupled to the body sensor and the BIOS, and the record table is stored in the embedded controller. When the body sensor detects a body contact, the embedded controller is configured to set the sensing parameter of the record table as a first value. When the body sensor detects a body contact, the embedded controller is configured to set the sensing parameter of the record table as a first value.

In an embodiment of the invention, the screen adjusting module includes a processor, a BIOS, and an embedded controller. The processor is coupled to the G-sensor, and the BIOS is coupled to the processor. The embedded controller is coupled to the body sensor and the BIOS. The embedded controller is configured to change the sensing parameter recorded in the record table from the first value to a second value, and send an interruption signal to the BIOS. The BIOS is configured to search for a sensing parameter recorded in a record table in response to the interruption signal, and generate a notification signal according to the sensing parameter. The processor is further configured to obtain a tilt status of the electronic device according to the G-sensor in response to the notification signal. The processor determines whether to adjust the screen displaying mode of the electronic device according to the tilt status of the electronic device.

In an embodiment of the invention, the body sensor includes a first body sensor and a second body sensor. The first body sensor is disposed on a first side of the body of the electronic device, and the second body sensor is disposed on a second side of the body of the electronic device opposite to the first side.

In an embodiment of the invention, a midpoint line of the first side and the second side is substantially parallel to a reference line. The reference line is a connection line of the two eyes of a user viewing the electronic device when the electronic device is in a screen displaying mode.

Based on the above, the electronic device proposed in the invention determines whether or not to adjust a screen displaying mode based on whether or not the body sensor has detected a body contact. This effectively improves the problem not being able to comply with both an automatic rotating display as well as user experience.

To make the above features and advantages of the invention more comprehensible, several embodiments accompanied with drawings are described in detail as follows.

### BRIEF DESCRIPTION OF THE DRAWINGS

FIG. 1 is a block diagram of an electronic device according to an embodiment of the invention.

FIG. 2 is a schematic diagram of an electronic device according to an embodiment of the invention.

FIG. 3 is a schematic diagram of an electronic device according to another embodiment of the invention.

FIG. 4A to FIG. 4C are schematic diagrams of an electronic device being used according to an embodiment of the invention.

FIG. 5 is a flow chart of a method for adjusting a screen displaying mode according to an embodiment of the invention.

### DESCRIPTION OF EMBODIMENTS

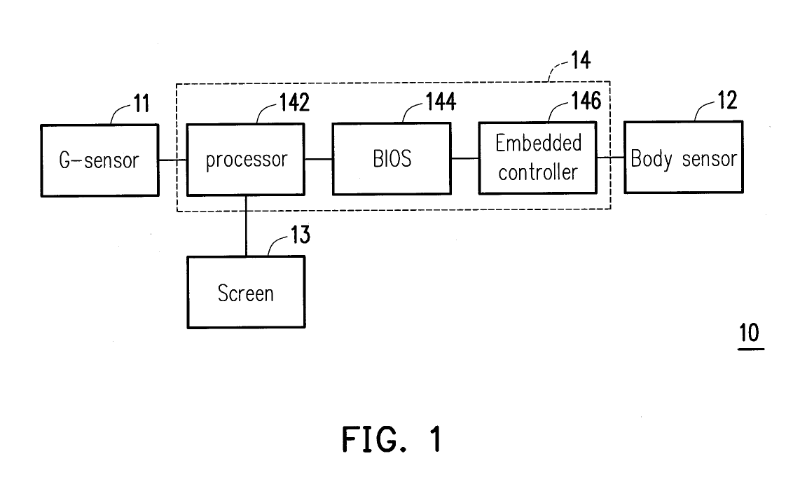

FIG. 1 is a block diagram of an electronic device according to an embodiment of the invention. Referring to FIG. 1, the embodiment, the electronic device 10 an electronic device with a display function, such as a mobile phone, Smartphone, or a Tablet PC. Or, in an embodiment, the electronic device 10 may have no display function, depending on practical requirements.

In the present embodiment, the electronic device 10 includes a body sensor 12, a gravity sensor (G-sensor) 11, a screen 13, and a screen adjusting module 14.

The G-sensor 11 is configured to detect a tilt status or tilt angle of the electronic device 10. In an embodiment, the G-sensor 11 may include an element such as an acceleration sensor, but is not limited thereto.

The body sensor 12 is disposed on a body of the electronic device 10, and is configured to detect a body contact. In the present embodiment, the body sensor 12 is, for example, an optical sensor (such as infrared sensor), a pressure sensor, a temperature sensor, a proximity sensor, or a capacitive touch sensor, but is not limited thereto. In addition, the body sensor 12 may be one or more, depending on practical requirement.

The screen 13 is configured to display the current operating screen of the electronic device 10. In the present embodiment, the screen 13 includes various types of touch screens such as a resistive touch screen, a capacitive touch screen, an optical screen, an acoustic wave touch screen, or an electromagnetic touch screen. Or, in an embodiment, the screen 13 may be a conventional screen with only a display function, depending on practical requirements.

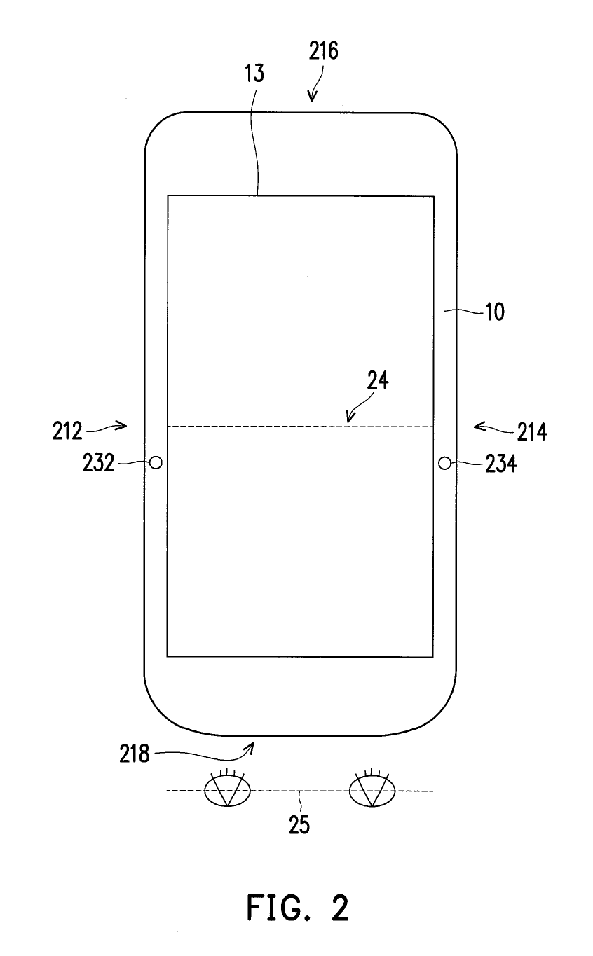

FIG. 2 is a schematic diagram of an electronic device according to an embodiment of the invention. Referring to FIG. 2, in the present embodiment, a body sensor 232 and a body sensor 234 are used as an example of the body sensor 12. However, in an embodiment, the body sensor 12 may only include one of the body sensors 232 or 234, or include more body sensors, depending on practical requirement.

In the present embodiment, the body of the electronic device 10 includes sides 212, 214, 216 and 218. A first distance exists between the side 212 and 214, and a second distance exists between the side 216 and 218. The first distance is smaller than (or equal to) the second distance. In the present embodiment, the body sensor 232 is disposed on the side 212 of the electronic device 10, and the body sensor 234 is disposed on the side 214 of the electronic device 10.

More particularly, in the present embodiment, a midpoint line 24 of the first side 212 and the second side 214 of the electronic device 10 is substantially parallel to a reference line. The reference line is, for example, a connection line 25 of the two eyes of a user viewing the electronic device 10 (or screen 13) when the electronic device 10 is in a screen displaying mode. In addition, the preset screen displaying mode is, for example, defined in advance according to a set position of the body sensor 232 and the body sensor 234. For example, in the present embodiment, the body sensor 232 and the body sensor 234 are disposed on the side 212 and the side 214 with the smaller distance. Thus, in the present embodiment, the preset screen displaying mode of the electronic device 10 may be defined as a vertical display mode, or the preset screen displaying mode of general smartphones or tablet PCs.

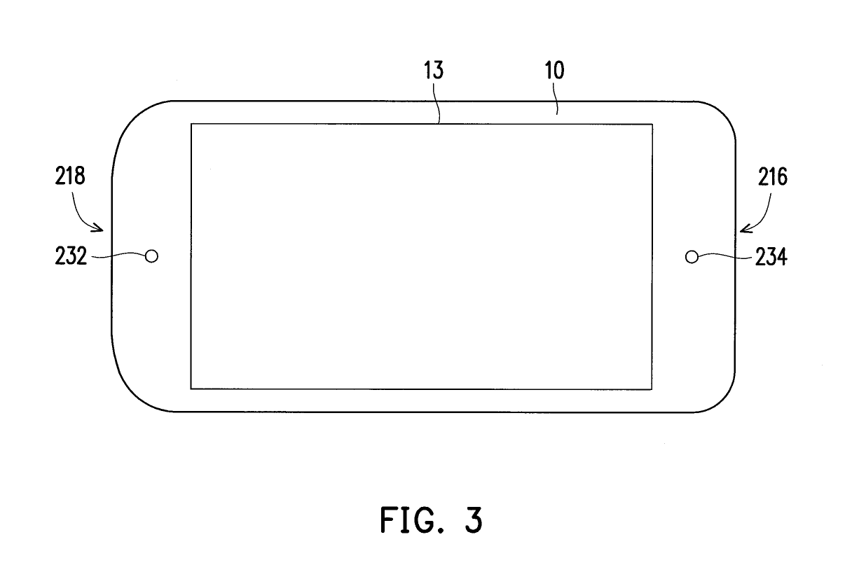

However, the invention is not limited thereto. For example, FIG. 3 is a schematic diagram of an electronic device according to another embodiment of the invention. Referring to FIG. 3, in the present embodiment, the body sensor 232 and the body sensor 234 are disposed on the side 216 and the side 218 with the larger distance. Thus, in the present embodiment, the preset screen displaying mode of the electronic device 10 may be defined as a horizontal display mode. Compared to the vertical display mode, the horizontal display mode is substantially the widescreen displaying mode that may be used in general smartphones or tablet PCs when displaying videos.

The screen adjusting module 14 is coupled to the body sensor 12, the G-sensor 11, and the screen 13, and is configured to determine if the body sensor 12 has detected a body contact. When the body sensor 12 detects a body contact, the screen adjusting module 14 does not adjust a screen displaying mode of the electronic device 10. On the contrary, when the body sensor 12 does not detect a body contact, the screen adjusting module 14 obtains a tilt status of the electronic device 10 through the G-sensor 11, and determines whether to adjust a screen displaying mode of the electronic device 10 according to the tilt status of the electronic device 10.

In the present embodiment, the electronic device 10 includes four types of screen displaying modes, wherein one of the basic screen displaying modes is the preset screen displaying mode of the electronic device 10. Each screen displaying mode corresponds to a tilt angle range (hereinafter known as a preset tilt angle range) of the electronic device 10. For convenience, the tilt angle of the electronic device 10 is defined between −180 degrees and 180 degrees. For example, if a center of the electronic device 10 is regarded as the axis, and the electronic device 10 under the status as shown in FIG. 2 is rotated 180 degrees toward the left, so that the positions of the side 216 and side 218 are switched and the positions of the side 212 and the side 214 are switched, the rotated electronic device 10 would have a tilt angle of −180 degrees. In addition, if a center of the electronic device 10 is regarded as the axis, and the electronic device 10 under the status as shown in FIG. 2 is rotated 180 degrees toward the right, so that the positions of the side 216 and side 218 are switched and the positions of the side 212 and the side 214 are switched, the rotated electronic device 10 would have a tilt angle of 180 degrees. When the tilt angle of the electronic device 10 falls within different preset tilt angle ranges of −45 degrees to 45 degrees, 45 degrees to 135 degrees, −45 degrees to −135 degrees, and −135 to 135 degrees, each preset tilt angle range corresponds to a specific screen display mode (hereinafter referred to as a target screen display mode). However, it should be noted that the preset tilt angle ranges are merely exemplary, and the scope of the invention is not limited thereto.

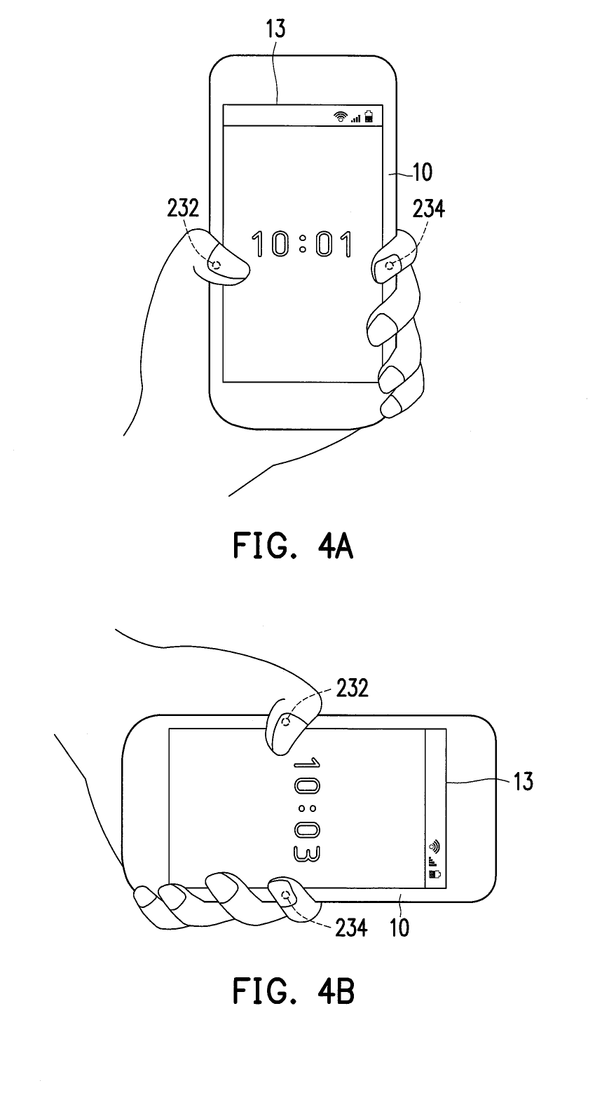

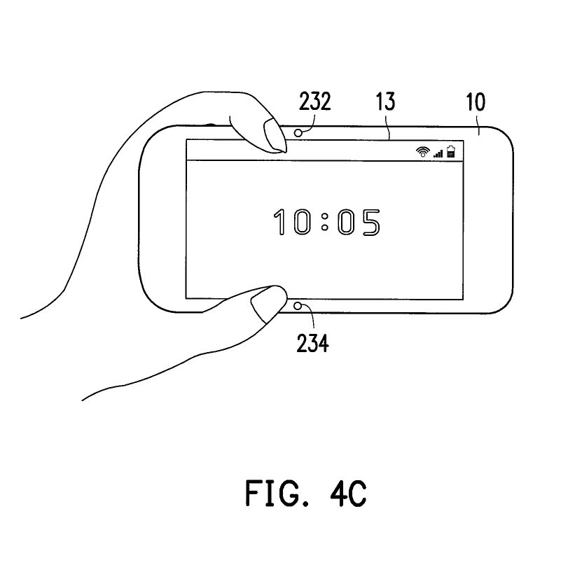

For example, FIG. 4A to FIG. 4C are schematic diagrams of an electronic device being used according to an embodiment of the invention. Referring to FIG. 4A, since the current tilt angle of the electronic device falls within the preset tilt angle range of −45 degrees to 45 degrees, the electronic device 10 is in a preset screen display mode (i.e., the vertical display mode of the embodiment of FIG. 2). In addition, as shown in FIG. 4A, the posture of the user holding the electronic device 10 is the normal operating posture. In addition, the fingers of the user press on the body sensor 232 and the body sensor 234, or are placed within a sensing range of the body sensor 232 and the body sensor 234. Thus, the body sensor 232 and the body sensor 234 both sense a body contact.

Next referring to FIG. 4B, if the user maintains the holding posture as shown in FIG. 4A and rotates the electronic device 10 (for example, the user is lying on a bed and maintaining the operating posture as shown in FIG. 4A), the electronic device 10 is rotated to fall within the preset tilt angle range of 45 degrees to 135 degrees (for example, 90 degrees). At this time, since the body sensor 232 and the body sensor 234 still detect the body contact, thus, the screen display mode of the electronic device 10 maintains the screen display mode (i.e., vertical display mode) of FIG. 4A. That is to say, unless one of the body sensor 232 and the body sensor 234 or a combination thereof do not sense a body contact, such as the user's hand leaving the electronic device 10 or the user changes a holding posture of the electronic device 10, the screen adjusting module 14 would not adjust the screen display mode of the electronic device 10.

Next referring to FIG. 4C, it is assumed that the tilt angle of electronic device 10 is maintained in the preset tilt angle range of 45 degrees to 135 degrees as shown in FIG. 4B (for example 90 degrees), and the user has changed a holding posture of the electronic device 10. For example, the user may put the electronic device 10 in horizontal, and holds the electronic device 10 as the holding posture shown in FIG. 4C. At this time, if the fingers of the user simultaneously or sequentially leave the sensing range of the body sensor 232 and the body sensor 234, the screen adjusting module 14 may determine whether to adjust the screen display mode of the electronic device 10 according to the tilt status of the electronic device 10.

For example, the screen adjusting module 14 determines the current screen display mode corresponding to the tilt angle according to the current tilt angle of the electronic device 10. Next, the screen adjusting module 14 may determine if the current screen displaying mode of the electronic device 10 (hereinafter the current screen displaying mode) is the same as the determined target screen displaying mode. When the current screen displaying mode of the electronic device 10 is different from the target screen displaying mode, the screen adjusting module 14 may adjust the screen displaying mode of the electronic device 10 from the current screen displaying mode to the target screen displaying mode.

As shown in FIG. 4C, as the user's fingers leave the sensing range of the body sensor 232 and the body sensor 234, since the screen adjusting module 14 determines that the current screen display mode and the target screen display mode is different, thus the screen adjusting module 14 would adjust the screen display mode of the electronic device 10 to the target screen display mode corresponding to the tilt angle range of 45 degrees to 135 degrees.

It should be noted that in the present embodiment, the screen adjusting module 14 would continually monitor and determine if the tilt angle of the electronic device changes from a preset tilt angle range (hereinafter referred to as a first preset tilt angle range) to another preset tilt angle range (hereinafter referred to as a second preset tilt angle range). Only when the tilt angle of the electronic device 10 has been changed from the first preset tilt angle range to the second preset tilt angle range, the screen adjusting module 14 determines whether the body sensor 12 has detected a body contact, and executes follow-up procedures.

For example, referring to FIG. 1, in an embodiment, the screen adjusting module 14 includes a processor 142, a BIOS 144, and an embedded controller 146. The processor 142 is coupled to the G-sensor 11, and the BIOS 144 is coupled to the processor 142. The embedded controller 146 is coupled to the body sensor 12 and the BIOS 144. The processor 142 is, for example, a central processing unit or a microprocessor, and may run a driving firmware of the G-sensor 11.

The processor 142 may know whether the tilt angle of the electronic device 10 has changed from a first preset tilt angle range to a second preset tilt angle range through the G-sensor 11. When the processor 142 knows that the tilt angle of the electronic device 10 has changed from the first preset tilt angle range to the second preset tilt angle range, the processor 142 may send a query signal to the BIOS 144 to query if the body sensor 12 has detected a body contact. Then, the BIOS 144 may search for a sensing parameter recorded in a record table in response to the query signal, and generates a response signal according to the sensing parameter. In the present embodiment, the record table is, for example, recorded in the memory of the embedded controller 146, and is maintained by the embedded controller 146. For example, in the present embodiment, when the body sensor 12 detects a body contact, the embedded controller 146 sets the sensing parameter of the record table as a first value (for example, a bit value “1”). By contrast, when the body sensor 12 does not detect a body contact, the embedded controller 146 sets the sensing parameter of the record table as a second value (for example, a bit value “0”). That is to say, the BIOS 144 searches for the sensing parameter through the embedded controller 146, and sends a corresponding response signal according to the sensing parameter to the processor 142. Then, the processor 142 knows whether the body sensor 12 has detected a body contact according to the response signal, and determines whether or not to adjust the screen display mode of the electronic device.

For example, in one embodiment, if the processor 142 knows that the body sensor 12 has not detected a body contact, then the processor 142 determines the target screen display mode according to the current tilt angle of the electronic device 10. Through the operating system of the processor 142, an adjusting instruction corresponding to the target screen display mode is transmitted to the screen 13, and the screen 13 displays an operating screen after adjustment. Or, in another embodiment, the processor 142 may directly transmit an adjusting instruction corresponding to the target screen display mode to the screen 13 through a video graphics array (VGA) interface, so that the screen 13 displays an adjusted operating screen.

However, the invention is not limited thereto. In an embodiment, when the body sensor 12 does not detect a body contact, the embedded controller 146 not only changes the sensing parameter recorded in the record table from the first value to a second value, the embedded controller 146 simultaneously sends an interruption signal to the BIOS 144. Then, the BIOS 144 searches for a sensing parameter recorded in a record table in response to the interruption signal, and generates a notification signal according to the sensing parameter. Next, the processor 142 further obtains a tilt status of the electronic device 10 according to the G-sensor 11 in response to the notification signal. The processor 142 determines whether to adjust the screen displaying mode of the electronic device 10 according to the tilt status of the electronic device 10.

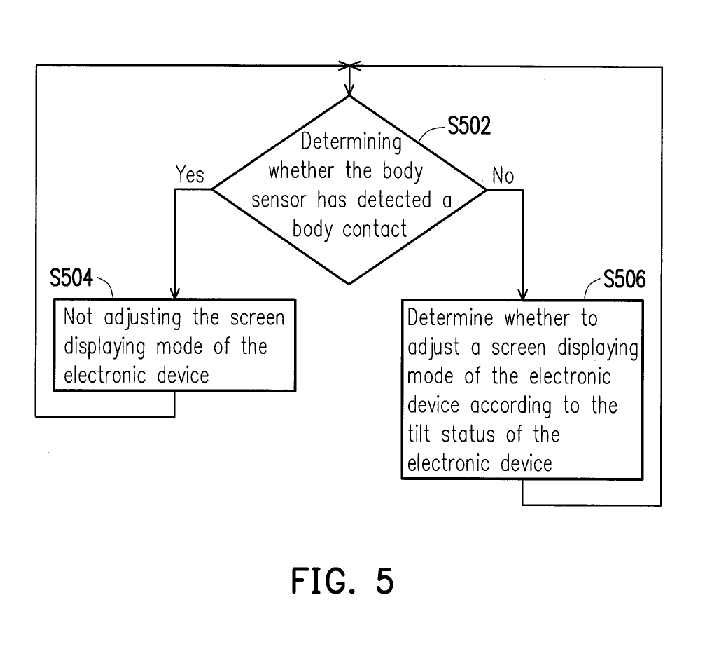

FIG. 5 is a flow chart of a method for adjusting a screen displaying mode according to an embodiment of the invention. Referring to FIG. 1 and FIG. 5, in step S502, the screen adjusting module 14 determines whether the body sensor 12 has detected a body contact. When the body sensor 12 detects a body contact, in step S504, the screen adjusting module 14 does not adjust the screen displaying mode of the electronic device 10. By contrast, when the body sensor 12 does not detect a body contact, in step S506, the screen adjusting module 14 determines whether to adjust a screen displaying mode of the electronic device 10 according to the tilt status of the electronic device 10. In addition, after steps S504 and S506, step S502 would be repeated.

However, the details of carrying out the aforementioned steps have been described in the above descriptions, and would not be repeated herein. In addition, each of the aforementioned steps may be carried out with software or firmware modules. When the software or firmware module is loaded in the processor of the electronic device 10, the steps of the method are correspondingly executed.

To sum up, the invention does not simply change the screen display mode of the electronic device according to the tilt status of the electronic device. The invention simultaneously determines whether to adjust the screen displaying mode of the electronic device according to the tilt status of the electronic device as well as the body sensor disposed on the electronic device. For example, when the user uses an electronic device (e.g., such as a smartphone) while lying on the bed, even the electronic device is horizontally placed, the invention allows the electronic device such as a smartphone to maintain a vertical display mode, and does not require the user to manually turn off a function such as an automatic rotating display function. Accordingly, the invention effectively improves the problem of not being able to comply with both an automatic rotating display as well as user experience.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A method for adjusting a screen displaying mode, adapted for an electronic device with at least one body sensor, the method comprising:
determining whether the at least one body sensor has detected a body contact;
when the at least one body sensor detects the body contact, not adjusting the screen displaying mode of the electronic device; and
when the at least one body sensor does not detect a body contact, determining whether to adjust the screen displaying mode of the electronic device according to a tilt status of the electronic device.

2. The method for adjusting a screen displaying mode as claimed in claim 1, wherein the step of determining whether to adjust the screen displaying mode of the electronic device according to the tilt status of the electronic device comprises:
determining a target screen displaying mode corresponding to a tilt angle of the electronic device;
determining if a current screen displaying mode of the electronic device is the same as the target screen displaying mode of the electronic device; and
when the current screen displaying mode of the electronic device is different from the target screen displaying mode of the electronic device, adjusting the screen displaying mode of the electronic device from the current screen displaying mode to the target screen displaying mode.

3. The method for adjusting a screen displaying mode as claimed in claim 1, wherein the step of determining whether the at least one body sensor has detected the body contact comprises:
determining if a tilt angle of the electronic device has changed from a first preset tilt angle range to a second preset tilt angle range; and
when the tilt angle of the electronic device has changed from the first preset tilt angle range to the second preset tilt angle range, then determining if the at least one body sensor has detected the body contact.

4. The method for adjusting a screen displaying mode as claimed in claim 1, wherein the step of determining whether the at least one body sensor has detected the body contact comprises:
sending a query signal to a basic input output system (BIOS) of the electronic device;
the BIOS searching for a sensing parameter recorded in a record table in response to the query signal, and generating a response signal according to the sensing parameter; and
determining whether the at least one body sensor has detected the body contact according to the response signal.

5. The method for adjusting a screen displaying mode as claimed in claim 4, wherein the record table is stored in an embedded controller of the electronic device, the method further comprising:
when the at least one body sensor detects the body contact, the embedded controller sets the sensing parameter of the record table as a first value; and
when the at least one body sensor does not detect the body contact, the embedded controller sets the sensing parameter of the record table as a second value.

6. The method for adjusting a screen displaying mode as claimed in claim 1, wherein the step of determining whether to adjust the screen displaying mode of the electronic device according to the tilt status of the electronic device comprises:
an embedded controller of the electronic device changing a sensing parameter recorded in a record table from the first value to a second value, and sending an interruption signal to a BIOS of the electronic device;
the BIOS searching for the sensing parameter recorded in the record table in response to the interruption signal, and generating a response signal according to the sensing parameter; and
obtaining the tilt status according to a G-sensor of the electronic device in response to the notification signal, and determining whether to adjust the screen displaying mode of the electronic device according to the tilt status of the electronic device.

7. The method for adjusting a screen displaying mode as claimed in claim 1, wherein the at least one body sensor comprises a first body sensor and a second body sensor, the first body sensor is disposed on a first side of a body of the electronic device, and the second body sensor is disposed on a second side of the body of the electronic device opposite to the first side.

8. The method for adjusting a screen displaying mode as claimed in claim 7, wherein a midpoint line of the first side and the second side is substantially parallel to a reference line, and the reference line is a connection line of two eyes of a user viewing the electronic device when the electronic device is in a preset screen displaying mode.

9. The method for adjusting a screen displaying mode as claimed in claim 1, further comprising:
defining a preset screen displaying mode of the electronic device according to a set position of the at least one body sensor.

10. An electronic device, comprising:
at least one body sensor, respectively configured to sense a body contact;
a G-sensor, configured to detect a tilt status of the electronic device; and
a screen adjusting module, coupled to the least one body sensor and the G-sensor, configured to determine whether the at least one body sensor has detected a body contact,
wherein when the at least one body sensor detects the body contact, the screen adjusting module does not adjust a screen displaying mode of the electronic device,
wherein when the at least one body sensor does not detect the body contact, the screen adjusting module determines whether to adjust the screen displaying mode of the electronic device according to the tilt status of the electronic device.

11. The electronic device as claimed in claim 10, wherein the screen adjusting module is further configured to determine a target screen displaying mode corresponding to a tilt angle of the electronic device,
wherein the screen adjusting module further determines if a current screen displaying mode of the electronic device is the same as the target screen displaying mode,
wherein when the current screen displaying mode of the electronic device is different from the target screen displaying mode, the screen adjusting module is further configured to adjust the screen displaying mode of the electronic device from the current screen displaying mode to the target screen displaying mode.

12. The electronic device as claimed in claim 10, wherein the screen adjusting module further determines if a tilt angle of the electronic device has changed from a first preset tilt angle range to a second preset tilt angle range,
wherein when the tilt angle of the electronic device has changed from the first preset tilt angle range to the second preset tilt angle range, the screen adjusting module then determining if the at least one body sensor has detected the body contact.

13. The electronic device as claimed in claim 10, wherein the screen displaying module comprises a processor and a basic input output system (BIOS), the processor is coupled to the G-sensor, and the BIOS is coupled to the processor,
wherein the processor sends a query signal to the BIOS,
wherein the BIOS searches for a sensing parameter recorded in a record table in response to the query signal, and generates a response signal according to the sensing parameter,
wherein the processor further determines if the at least one body sensor has detected the body contact according to the response signal.

14. The electronic device as claimed in claim 13, wherein the screen displaying module comprises an embedded controller, the embedded controller is coupled to the at least one body sensor and the BIOS, and the record table is stored in the embedded controller,
wherein when the at least one body sensor detects the body contact, the embedded controller sets the sensing parameter of the record table as a first value,
wherein when the at least one body sensor does not detect the body contact, the embedded controller sets the sensing parameter of the record table as a second value.

15. The electronic device as claimed in claim 10, wherein the screen displaying module comprises a processor, a BIOS, and an embedded controller, the processor is coupled to the G-sensor, the BIOS is coupled to the processor, and the embedded controller is coupled to the at least one body sensor and the BIOS,
wherein the embedded controller changes a sensing parameter recorded in a record table from the first value to a second value, and sends an interruption signal to the BIOS,
wherein the BIOS searches for the sensing parameter recorded in the record table in response to the interruption signal, and generates a notification signal according to the sensing parameter,
wherein the processor further obtains a tilt status of the electronic device according to the G-sensor in response to the notification signal, and the processor determines whether to adjust the screen displaying mode of the electronic device according to the tilt status of the electronic device.

16. The electronic device as claimed in claim 10, wherein the at least one body sensor comprises a first body sensor and a second body sensor, the first body sensor is disposed on a first side of a body of the electronic device, and the second body sensor is disposed on a second side of the body of the electronic device opposite to the first side.

17. The electronic device as claimed in claim 16, wherein a midpoint line of the first side and the second side is substantially parallel to a reference line, and the reference line is continuation line of two eyes of a user viewing the electronic device when the electronic device is in a preset screen displaying mode.

18. The electronic device as claimed in claim 10, wherein the screen adjusting module further defines a preset screen displaying mode of the electronic device according to a set position of the at least one body sensor.
